(19) United States
(12) Patent Application Publication
(10) Pub. No.: US 2026/0152658 A1
(43) Pub. Date: Jun. 4, 2026

(54) RAPID 3D PRINTING OF AEROGELS WITH BIOINSPIRED SURFACE STRUCTURES FOR SOLAR STEAM GENERATION

(71) Applicants: Xiangfan Chen, Gilbert, AZ (US); Luyang Liu, Chandler, AZ (US); Chao Ma, Gilbert, AZ (US)

(72) Inventors: Xiangfan Chen, Gilbert, AZ (US); Luyang Liu, Chandler, AZ (US); Chao Ma, Gilbert, AZ (US)

(21) Appl. No.: 19/397,412

(22) Filed: Nov. 21, 2025

Related U.S. Application Data
(60) Provisional application No. 63/727,873, filed on Dec. 4, 2024.

(51) Int. Cl. C09D 133/26; B29C 64/124; B29K 77/00; B29K 105/00; B29K 105/16; B29K 507/04; B33Y 10/00; B33Y 70/10; B33Y 80/00; C02F 1/14; C02F 103/08; C08F 20/56; C08K 9/02; C09D 4/00; C09D 7/62; F24S 10/80; F24S 70/20

(52) U.S. Cl. CPC C09D 133/26; B33Y 70/10; B33Y 80/00; C02F 1/14; C08F 20/56; C09D 4/00; C09D 7/62; F24S 10/80; F24S 70/20; B29C 64/124; B29K 2077/00; B29K 2105/0061; B29K 2105/16; B29K 2507/04; B33Y 10/00; C02F 2103/08; C08K 9/02

(57) ABSTRACT

A polyacrylamide-based aerogel may be an efficient solar vapor generation device. Internal pores of the polyacrylamide-based aerogel may provide capillary forces while elongated surface channels provide a transport force in response to the polyacrylamide-based aerogel contacting liquid. The polyacrylamide-based aerogel may be formed from a photocurable resin doped with reduced graphene oxide particles. The photocurable resin may be printed in layers in a micro continuous liquid interface projection process to form a polyacrylamide-based hydrogel. The polyacrylamide-based hydrogel may be immersed in water to form a swollen hydrogel structure. The swollen hydrogel structure may be frozen. The frozen hydrogel structure may be dried to form a polyacrylamide-based aerogel structure.

### CROSS-REFERENCE TO RELATED APPLICATIONS

This application claims priority to and the benefit of, U.S. Provisional Patent Application No. 63/727,873, entitled “RAPID 3D PRINTING OF AEROGELS WITH BIOINSPIRED SURFACE STRUCTURES FOR SOLAR STEAM GENERATION,” filed on Dec. 4, 2024, which is hereby incorporated by reference in its entirety for all purposes, but except for any subject matter disclaimers or disavowals, and except to the extent that the incorporated material is inconsistent with the express disclosure herein, in which case the language in this disclosure shall control.

### TECHNICAL FIELD

The present disclosure relates to solar steam generation, and in particular, systems and methods of manufacturing three-dimensional polymeric-based aerogels for use in solar steam generation.

### BACKGROUND

The global scarcity of freshwater remains one of the most critical challenges for sustaining human life. Desalination of seawater and purification of contaminated water are two highly effective approaches to mitigating this issue. Among the various methods explored for desalination and purification, solar steam generation has gained significant attention due to its potential efficiency. Solar steam generation utilizes solar energy to heat seawater or polluted water at the evaporator-air interface, leading to the evaporation of water, which is subsequently condensed into freshwater. Inefficiencies in common water transport systems and methods, which are typically reliant on a single water transportation driving force, limit the performance and effectiveness of solar steam generation systems. Further, fabricating solar steamers with intricate three-dimensional surface features is time-intensive and cost-prohibitive due to the complexity of producing molds or dies with fine structural details. Additionally, achieving homogeneous doping of reduced graphene oxide (rGO) in these systems is challenging, as rGO cannot be dissolved uniformly in the precursor liquid materials used in the molding process. Accordingly, improved solar steam generation systems remain desirable. The improved solar steam generation systems disclosed herein provide for improved environmental and agricultural protection. The improved solar steam generation systems disclosed herein provide for improved water vapor absorption, water transportation, water purification, and seawater desalination. The improved solar steam generation systems disclosed herein provide for improved solar energy utilization.

### BRIEF DESCRIPTION OF THE DRAWINGS

With reference to the following description and accompanying drawings:

FIG. 1A illustrates a micro continuous liquid interface projection (μCLIP) technique, a step of a method of fabricating a PAAm-based aerogel, in accordance with various embodiments;

FIG. 1B illustrates a mixture for the μCLIP technique in accordance with various embodiments;

FIG. 1C illustrates an as-printed PAAm-based hydrogrel structure, a step of a method of fabricating a PAAm-based aerogel, in accordance with various embodiments;

FIG. 1D illustrates PAAm-based aerogel structure produced through swelling and freeze-drying, steps of a method of fabricating a PAAm-based aerogel, in accordance with various embodiments;

FIG. 1E illustrates a scanning electron microscope (SEM) image of the aerogel, in accordance with various embodiments;

FIG. 2A illustrates a PAAm-based aerogel structure without channels, in accordance with various embodiments;

FIG. 2B illustrates a PAAm-based aerogel structure with straight surface channels, in accordance with various embodiments;

FIG. 2C illustrates a PAAm-based aerogel structure with reverse Laplace surface outer channels, in accordance with various embodiments;

FIG. 2D illustrates a PAAm-based aerogel structure with reverse Laplace inner channels, in accordance with various embodiments;

FIG. 3 illustrates time-lapse images of the water transportation for different PAAm-based aerogel structures, in accordance with various embodiments;

FIG. 4A illustrates a graph of transportation distance of water over time for different PAAm-based aerogel structures, in accordance with various embodiments;

FIG. 4B illustrates a graph of transportation speeds as a function of time for different PAAm-based aerogel structures, in accordance with various embodiments;

FIG. 4C illustrates a graph of mass of transported water over time for different PAAm-based aerogel structures, in accordance with various embodiments;

FIG. 4D illustrates a graph of mass of saturated transported water for different structures, in accordance with various embodiments;

FIG. 5 illustrates solar steam generation by using PAAm-based aerogels doped with rGO particles, in accordance with various embodiments;

FIG. 6A illustrates cumulative mass change due to water evaporation over time for water and aerogel samples printed from resins with different rGO particle concentrations under one sun irradiation, in accordance with various embodiments;

FIG. 6B illustrates surface temperature change of aerogel samples printed from resins with different rGO particle concentrations and water relative to heating time under one sun irradiation, in accordance with various embodiments; and

FIG. 7 illustrates a method of manufacturing a polyacrylamide-based aerogel, in accordance with various embodiments.

### DETAILED DESCRIPTION

The following description is of various exemplary embodiments only, and is not intended to limit the scope, applicability, or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

The global scarcity of freshwater is a critical global challenge and remains one of the most critical challenges for sustaining human life. Desalination and water purification, particularly through solar steam generation, offer highly effective solutions by converting seawater and polluted water into freshwater using solar energy. Among the various methods explored for desalination and purification, solar steam generation has gained significant attention due to its potential efficiency. This technique utilizes solar energy to heat seawater or polluted water at the evaporator-air interface, leading to the evaporation of water, which is subsequently condensed into freshwater. A commonly used medium for enhancing this process is aerogels doped with reduced graphene oxide (rGO). These materials improve water transport and solar energy absorption by facilitating water transport from the container, with the doped rGO absorbing sunlight and converting it into thermal energy to evaporate the transported water. In many conventional solar steam generators, water is typically transported from the bottom to the top of the system, driven primarily by capillary forces generated within the internal pore structure. However, conventional aerogels face limitations due to inefficient water transport driven solely by capillary forces. The inefficiency of water transport through these irregular pores limits the overall performance and effectiveness of solar steam generation systems.

A polyacrylamide (PAAm)-based aerogel with longitudinal grooves of the present disclosure, fabricated via micro continuous liquid interface projection (μCLIP) and freeze-drying, mimics the dual-source water transport mechanisms found in various biological systems such as desert grasses with leaves having longitudinal grooves. Introduction of additional driving forces enhances water transportation efficiency. A dual-force water transport system of the present disclosure improves water transport in solar steam generators. An aerogel with multiple water transportation driving forces of the present disclosure improves water transport in solar steam generators.

Capillary forces may provide a driving force for water contacting the surface of solar steam generation systems. Capillary forces may facilitate absorption or movement of water or other liquid along the surface and throughout the internal structure of solar steam generation systems. Solar steam generation systems with features providing various types or directions of capillary forces enhance the effectiveness of the solar steam generation systems.

Internal pores of a solar steam generation systems may provide a first driving force. Internal pores may extend from the surface to the internal structure of the solar steam generation system. For example, the internal pores of leaves transport water absorbed by the roots, enabling efficient water distribution.

Longitudinal channels may provide a second driving force. Longitudinal channels may extend inward from the surface of the solar steam generation system. In other words, longitudinal channels may define a surface feature or a peripheral shape of the solar steam generation system. Longitudinal channels may transport water or other liquid through the structures. Internal pores or channels may provide for efficient water distribution throughout the structures. For example, simultaneous with the capillary forces of the leaf pores, internal channels or grooves within the leaves also generate capillary forces, facilitating the movement of condensed dew droplets collected from fog.

Previously developed aerogel-based solar steamers, which rely on a single water transportation driving force, are typically fabricated using molding-based techniques. However, incorporation of sophisticated or complex three-dimensional (3D) surface features is required to create solar steamers capable of utilizing multiple water transportation mechanisms. Fabricating such intricate 3D structures through conventional molding methods is both time-intensive and cost-prohibitive due to the complexity of producing molds or dies with fine structural details. Additionally, achieving homogeneous doping of rGO in these systems is challenging because rGO cannot be dissolved uniformly in the precursor liquid materials used in the molding process. Prior attempts to solve this problem applied or coated a thin layer of rGO particles on the surface of the fabricated aerogel. This coated led to limitations in the energy absorption. These limitations further hindered the overall efficiency and performance of aerogel-based solar steamers fabricated by traditional methods.

The present disclosure provides not only for a novel dual-force water transport system (i.e. a novel aerogel with multiple water transportation driving forces), but a novel method of manufacturing the dual-force water transport system.

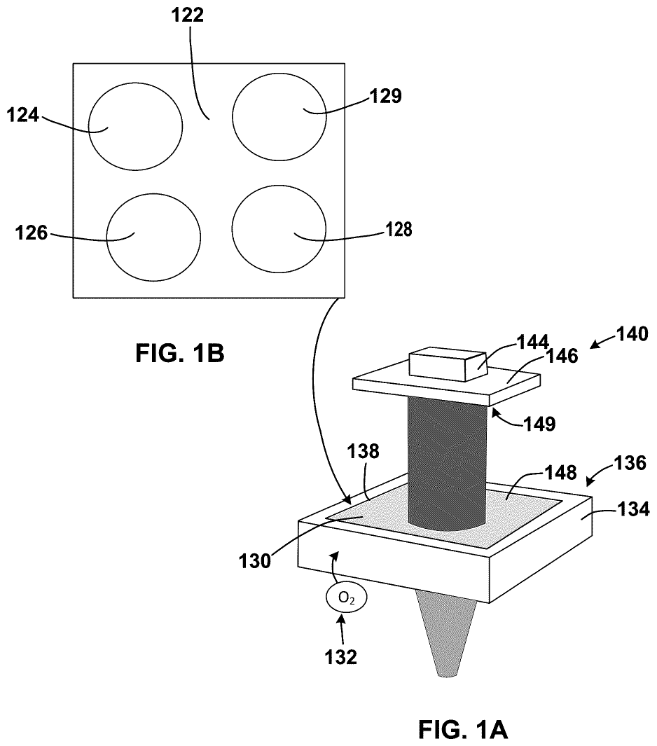

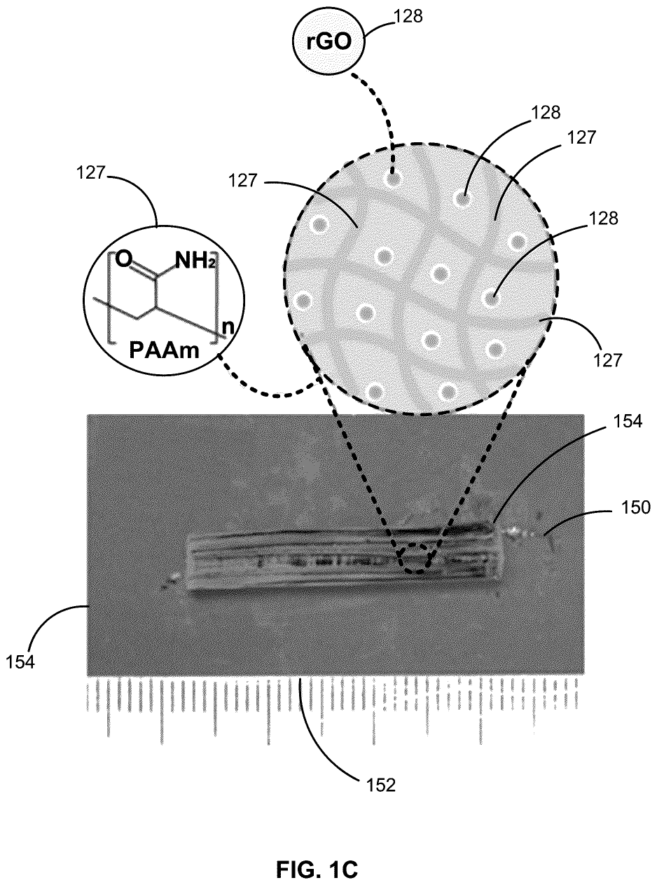

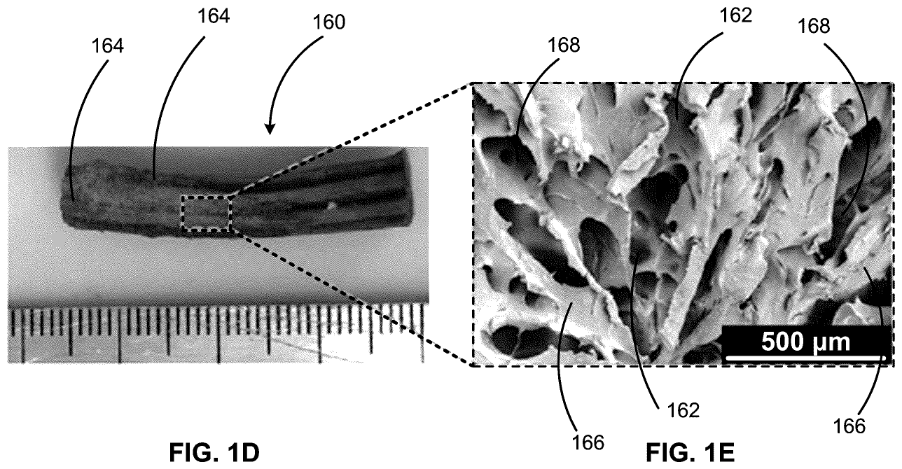

With reference to FIGS. 1A-1E, a 3D PAAm-based aerogel structures 160 with internal pores 162, surface channels 164, or both internal pores 162 and surface channels 164 may be manufactured using a novel vat photopolymerization-based 3D printing technique (i.e. μCLIP) followed by freeze-drying.

With reference to FIGS. 1A and 1B, a first mixture 120 may be created. First mixture 120 may comprise a solvent 122 for a photocurable resin 130. In various embodiments, the solvent 122 may be deionized (DI) water. First mixture 120 may comprise a monomer 126. In various embodiments, the monomer 126 may be acrylamide (AAm). Acrylamide is preferred due to its advantageous properties such as high stability and hydrophilicity. First mixture 120 may comprise a crosslinker 124. In various embodiments, the crosslinker 124 may be N,N′-methylenebisacrylamide (MBAA). First mixture 120 may comprise a photoinitiator 129 for the photocurable resin 130. In various embodiments, the photoinitiator 129 may be TPO. First mixture 120 may comprise rGO particles 128 of various concentrations. The first mixture 120 may be fabricated by dissolving and mixing the monomer 126 (e.g. AAm), the crosslinker 124 (e.g. MBA), at least one photoinitiator 129 (e.g. TPO), and rGO particles 128 into the solvent 122 (e.g. DI water) to prepare photocurable resin 130.

With continued reference to FIGS. 1A-1E, rGO particles 128 may be directly mixed into the liquid photocurable resin 130. Mixing rGO particles 128 into the liquid photocurable resin 130 may achieve homogeneous doping of the rGO particles 128. The homogeneous doping of rGO particles 128 enhances energy absorption efficiency, further improving the solar steam generation rate (i.e. 2.1 kg m⁻² h⁻¹ under one-sun irradiation). During the printing process (detailed below), due to the high speed of μCLIP, a PAAm 127 structure is formed. Accordingly, during the printing process, a PAAm-based hydrogel structure 150 may be printed before significant segregation of the rGO particles 128 within the photocurable resin 130 occurs, as shown in FIGS. 1B and 1C. Additionally, the unused photocurable resin 130 may be kept or stored in an ultrasonic bath to further prevent rGO particle 128 segregation.

With continued reference to FIGS. 1A-1E, the photocurable resin 130 may undergo a vat photopolymerization-based 3D printing technique. The photocurable resin 130 may undergo μCLIP. In the μCLIP system 140, oxygen 132 from the atmosphere may diffuse through the oxygen-permeable membrane 134 of the resin bath 136 (as shown in FIG. 1A), inhibiting photopolymerization and creating a thin, polymerization-free zone 138 known as the “dead zone.” The polymerization-free zone 138 may allow for the unpolymerized photocurable resin 130 to continuously flow into the printing area, enabling rapid continuous printing (up to 50 μm/s for polymers). The μCLIP printing process may begin with slicing a computer-aided design (CAD) model of the desired structure into 2D images along the printing direction using a customized Matlab program, with a slicing thickness of 5 μm. A UV light engine 144 (for example, PRO6600 by Wintech Digital) equipped with a 385 nm UV light source and a digital micromirror device 146 (for example, by Texas Instruments) with a resolution of 3840×2160 may project these sliced images onto the transparent window 148 of the resin bath 136 with a pixel resolution of 5.8 μm×5.8 μm. Under the patterned UV light 142, the liquid photocurable resin 130 may be selectively polymerized into solid layers while the building platform, mounted on a motorized translation stage (for example, X-LSM200A-PTB2 by Zaber Technologies Inc.), may be elevated at a constant speed. A Complementary Metal-Oxide-Semiconductor (CMOS) camera 149 (for example, MU2003-BI by AmScope) may be used to monitor the focus of the projected images. The μCLIP process may be used to rapidly print the photocurable resin 130. The photocurable resin 130 may be printed into PAAm-based hydrogel structures 150. Used herein, printed may refer to any suitable 3D printing, additive manufacturing, or advanced manufacturing method.

The μCLIP process may significantly reduce fabrication time. The μCLIP process may provide for a fast printing speed of approximately 30 minutes for a 3-cm-long sample due to the continuous nature of the process. The μCLIP process may provide for producing a 3D polymeric-based aerogel for use in solar steam generation.

With brief reference to FIG. 1C, the printed photocurable resin 130 may form a PAAm-based hydrogel structure 150. The PAAm-based hydrogel structure 150 may comprise rGO particles 128 dispersed in PAAm 127. The hydrogel may comprise homogeneously doped rGO particles 128. The PAAm-based hydrogel structure 150 may comprise internal pores 152, longitudinal grooves 154, or both internal pores 152 and longitudinal grooves 154.

The printed PAAm-based hydrogel structure 150 may then be immersed in DI water for a period of time to ensure full swelling. The printed PAAm-based hydrogel structure 150 may then be immersed in DI water for between 12-48 hours. The printed PAAm-based hydrogel structure 150 may then be immersed in DI water for between 18-36 hours. In a preferred embodiment, the printed PAAm-based hydrogel structure 150 may then be immersed in DI water for about 24 hours.

The swollen PAAm-based hydrogel structure 150 may then be rapidly frozen. The swollen PAAm-based hydrogel structure 150 may be rapidly frozen in a freezer for a period of time. The swollen PAAm-based hydrogel structure 150 may be rapidly frozen in the freezer for between 6 and 24 hours. The swollen PAAm-based hydrogel structure 150 may be rapidly frozen in the freezer for between 8 and 18 hours. In a preferred embodiment, the swollen PAAm-based hydrogel structure 150 may be rapidly frozen in the freezer for about 12 hours. The freezer may be of a sufficiently cold temperature. The freezer may be between −60° C. and −20° C. The freezer may be of between −50° C. and −30° C. In a preferred embodiment, the freezer temperature may be about 40° C.

Subsequently, the frozen PAAm-based hydrogel structure 150 may be dried using a freeze dryer. For example, the frozen PAAm-based hydrogel structure 150 may be dried in a freezer such as the Benchtop Pro, SP Scientific. The frozen PAAm-based hydrogel structure 150 may be dried at a temperature between −75° C. and −35° C. The frozen PAAm-based hydrogel structure 150 may be dried at a temperature between −65° C. and −45° C. In a preferred embodiment, the frozen PAAm-based hydrogel structure 150 may be dried at a temperature of about −55° C. The frozen PAAm-based hydrogel structure 150 may be dried at a pressure between 100 mTorr and 200 mTorr. The frozen PAAm-based hydrogel structure 150 may be dried at a pressure between 125 mTorr and 175 mTorr. In a preferred embodiment, the frozen PAAm-based hydrogel structure 150 may be dried at a pressure of about 150 mTorr. The frozen PAAm-based hydrogel structure 150 may be dried for between 24 and 72 hours. The frozen PAAm-based hydrogel structure 150 may be dried for between 36 and 60 hours. In a preferred embodiment, the frozen PAAm-based hydrogel structure 150 may be dried for about 48 hours.

Freeze-drying may produce a PAAm-based aerogel structures 160. The PAAm-based aerogel structure 160, fabricated after swelling and freeze-drying of the printed PAAm-based hydrogel structure 150, may comprise a porous internal structure, as shown in FIGS. 1D and 1E, having internal pores 162. The internal pores 162 may comprise be micron-scale internal pores 162. The internal pores 162 may be disposed on an external surface 166 and extend into an internal surface 168 of the PAAm-based aerogel. The internal pores 162 may be disposed throughout the internal surface 168 or body of the PAAm-based aerogel structure 160. The internal pores 162 may be of irregular, or varying, shapes and sizes, as depicted in FIG. 1E. The internal pores 162 may be of an irregular, non-longitudinal shape, as depicted in FIG. 1E.

The porous internal structure of each PAAm-based aerogel structure 160 may comprise surface channels 164. The surface channels 164 may be elongated or longitudinal grooves disposed on or defining an external surface 166 of the PAAm-based aerogel structures 160. The surface channels 164 may be disposed on an external surface 166 and extend inward toward a center of the PAAm-based aerogel structures 160. The surface channels 164 may be disposed throughout the internal surface 166 or body of the PAAm-based aerogel structures 160. The surface channels 164 may be larger than the internal pores 162. In other words, the internal pores 162 may be disposed on the surface of the surface channels 164, as depicted in FIGS. 1D and 1E. The surface channels 164 may extend longitudinally through most or all of a length of the PAAm-based aerogel structures 160, as depicted in FIG. 1D.

The porous internal structure of the PAAm-based aerogel structures 160 may comprise both internal pores 162 and surface channels 164.

The PAAm-based aerogel structures 160 of the present invention may exhibit a transport distance exceeding 1.5 cm within 150 seconds. In a preferred embodiment, the PAAm-based aerogel structures 160 of the present invention may exhibit a transport distance exceeding 2 cm within 100 seconds. The PAAm-based aerogel structures 160 of the present invention may exhibit a rapid transport distance of approximately 0.6 cm in the first second. In a preferred embodiment, the PAAm-based aerogel structures 160 of the present invention may exhibit a rapid transport distance of approximately 0.8 cm in the first second. The PAAm-based aerogel structures 160 of the present invention may exhibit a high water evaporation rate of approximately 1.8 kg m⁻² h⁻¹ under one-sun irradiation. In a preferred embodiment, the PAAm-based aerogel structures 160 of the present invention may exhibit a high water evaporation rate (or steam generation rate) of approximately 2.1 kg m⁻² h⁻¹ under one-sun irradiation. These findings highlight the potential of the PAAm-based aerogel structures 160 of the present invention to effectively address water scarcity by significantly enhancing both water transport and evaporation performance.

The surface structural features (i.e. internal pores 162 and/or surface channels 164) of the PAAm-based aerogel structures 160 of the present disclosure, analogous to those of desert grass leaves, may demonstrate enhanced antigravity water transportation efficiency because of their multiple transport forces. The internal pores 162 and/or surface channels 164 of the PAAm-based aerogel structures 160 may demonstrate highly efficient water evaporation under solar irradiation. The internal pores 162 and/or surface channels 164 of the PAAm-based aerogel structures 160 may demonstrate both enhanced antigravity water transportation efficiency and highly efficient water evaporation under solar irradiation.

The PAAm-based aerogel structures 160 of the present disclosure may comprise a crosslinked polyacrylamide-based aerogel. The PAAm-based aerogel structures 160 may comprise micro-scale internal pores 162. The PAAm-based aerogel structures 160 may comprise longitudinal grooves forming surface channels 164. The PAAm-based aerogel structures 160 may comprise surface channels 164 with a reverse Laplace structure, may exhibit high water transportation efficiency and exceptional capillary rise capabilities, and may enable rapid antigravity water transport (0.8 cm s⁻¹ at the initial stage, 0.45 g within 10 minutes). The PAAm-based aerogel structures 160 may be doped with rGO particles 128 for enhanced solar absorption. The PAAm-based aerogel structures 160 may achieve a solar vapor generation rate of 2.1 kg m⁻² h⁻¹ under 1 sun irradiation. This highly efficient water transport and evaporation system offers significant potential for applications in microfluidics, water transportation and purification, energy management, and pollution abatement.

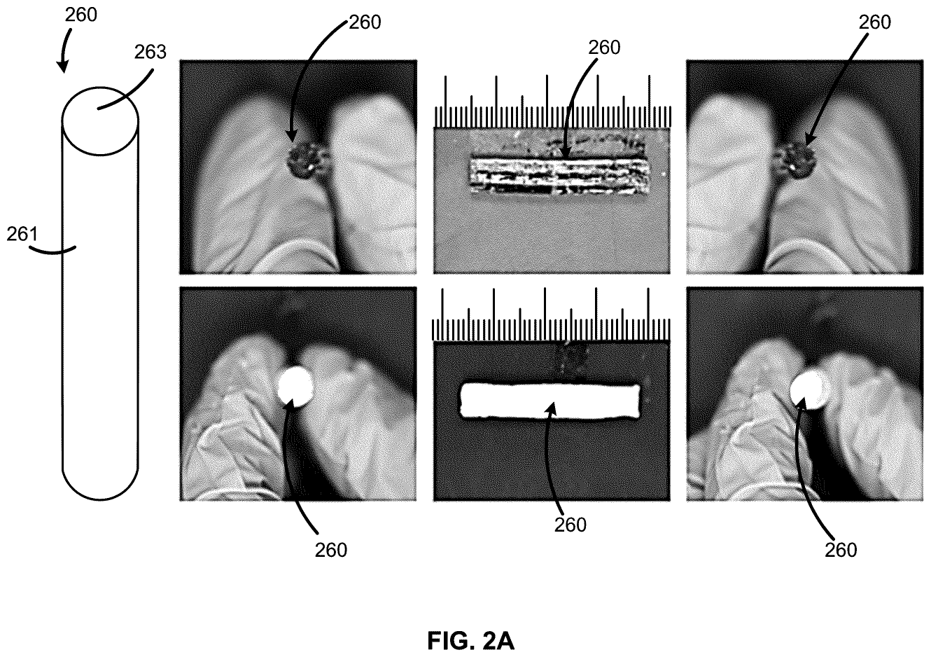

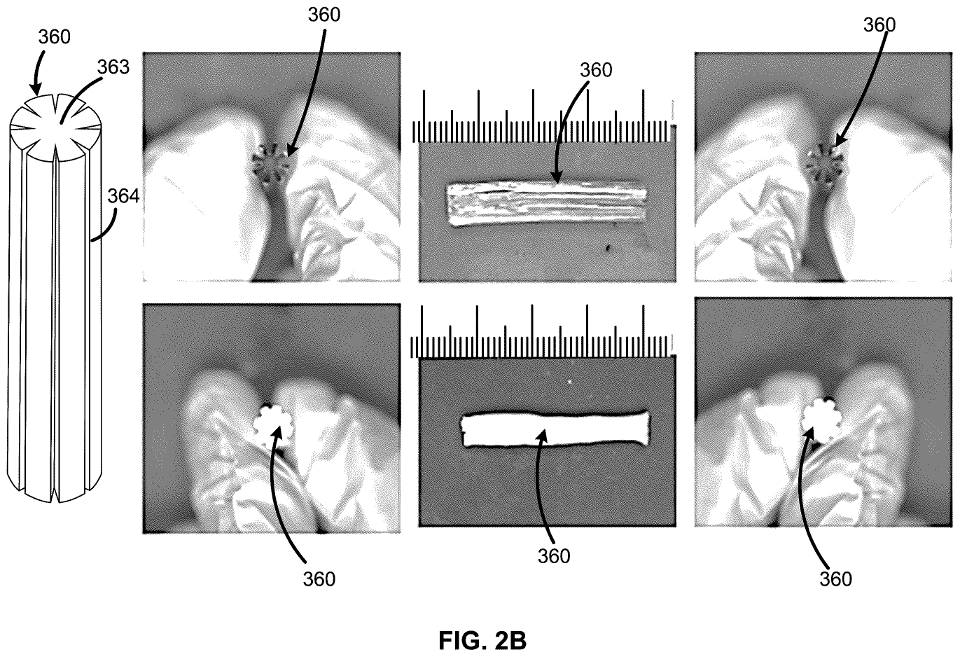

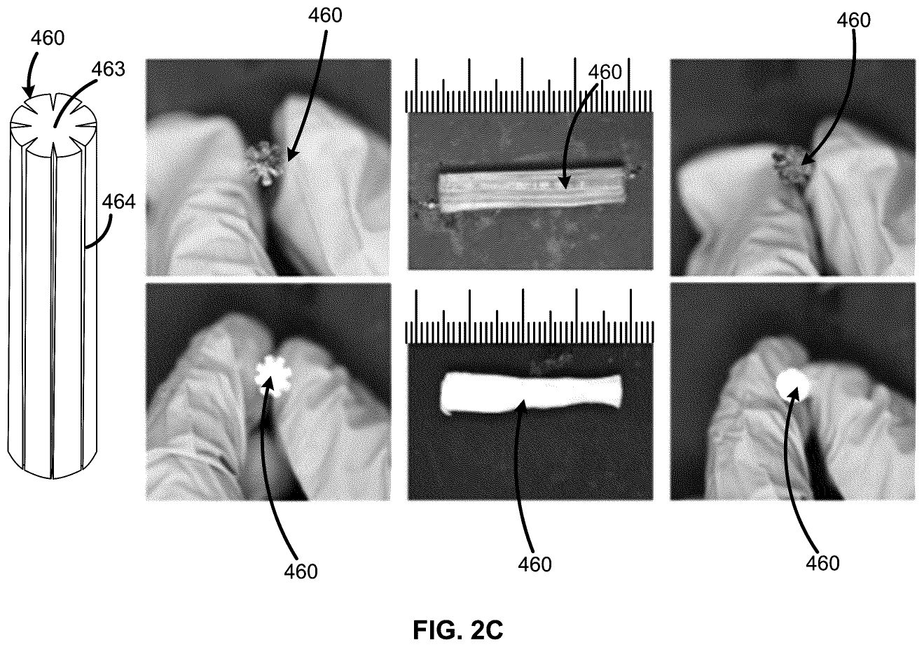

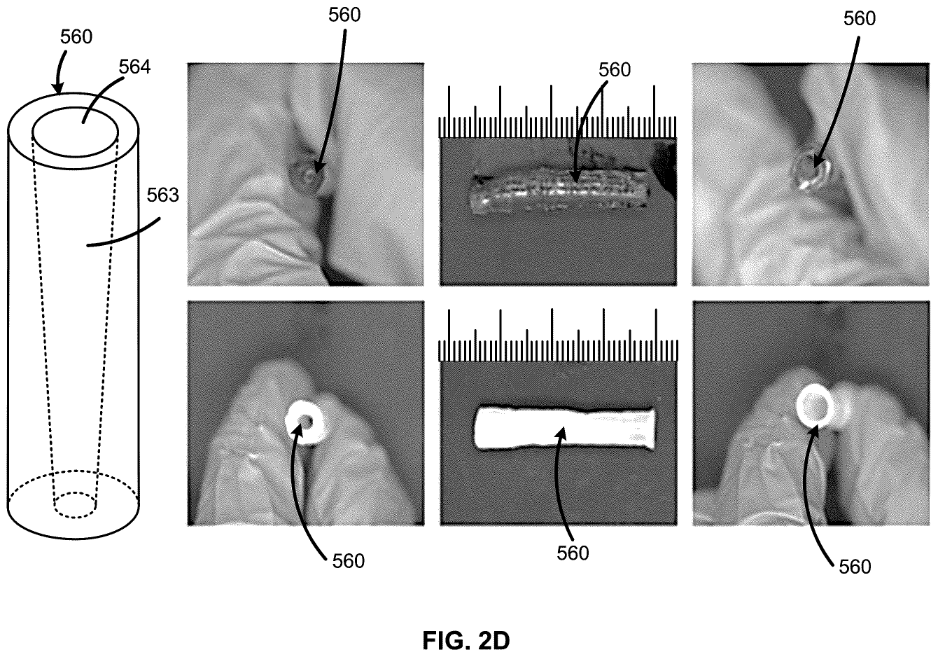

With reference to FIG. 2A, a PAAm-based aerogel structures 260 may comprise a smooth surface 261. In various embodiments, PAAm-based aerogel structures 260 may comprise a cylinder 263 without channels, (also referred to as “solid pillar structure 260”). With reference to FIG. 2B, a PAAm-based aerogel structures 360 may comprise a cylinder 363 with straight surface channels 364 (also referred to as “straight channel structure 360”). With reference to FIG. 2C, a PAAm-based aerogel structure 460 may comprise a cylinder 463 with reverse Laplace surface channels 464, (also referred to as “RL channel structure 460”). With reference to FIG. 2D, a PAAm-based aerogel structure 560 may comprise a cylinder 563 with a reverse Laplace inner channel 564 (also referred to as “inner RL structure 560”). It should be understood that cylinders 236, 363, 463, 563 may be generally cylindrical or elongate structures with rounded outer surfaces.

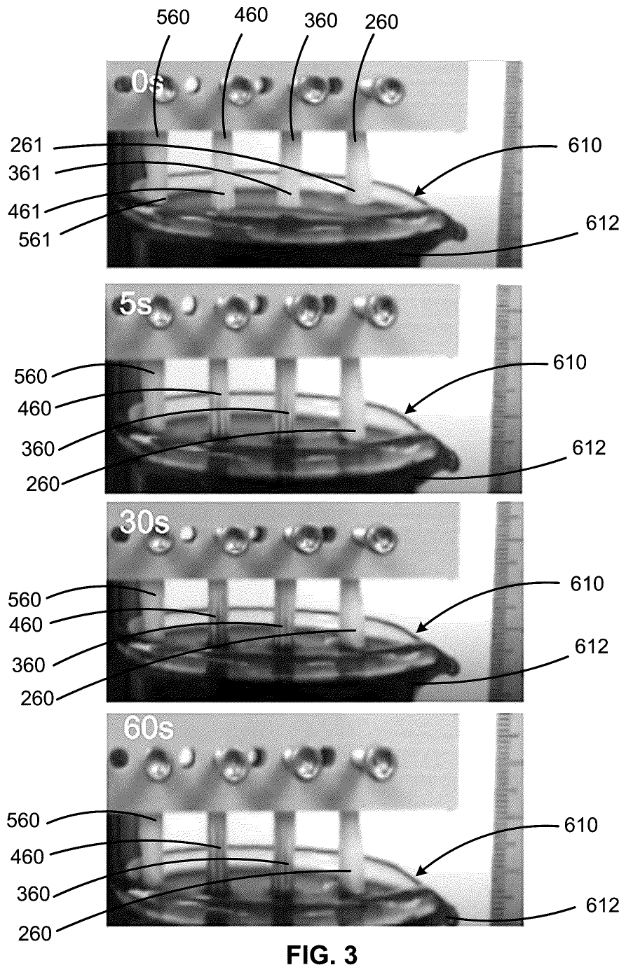

FIG. 3A illustrates the improved water transportation of the straight channel structures 360 and RL channel structures 460 over 0 seconds(s), 5 s, 30 s, and 60 s. In the illustrated example, for testing purposes, PAAm-based aerogels structures 260, 360, 460, 560 are shown without doping rGO particls 128. However, it is understood the PAAm-based aerogel structures 260, 360, 460, 560 of FIGS. 2A-2D may be formed with doping rGO particles 128, as described above with respect to PAAm-based aerogel structure 160.

With reference to FIG. 3, the PAAm-based aerogels structures 260, 360, 460, 560 may be placed in a bottom beaker 610 containing dyed water 612. For example, the dyed water 612 may be dyed with methylene blue. The bottom surfaces 261, 361, 461, 561 of PAAm-based aerogels structures 260, 360, 460, 560 may be immersed in the dyed water 612. FIG. 3 illustrates time-lapse images captured to observe the water transportation process. The distance of water rise and mass changes were measured. In various embodiments, the RL channel structures 460 and inner RL structures 560 offer excellent capillary rise capabilities, facilitating rapid antigravity water transport.

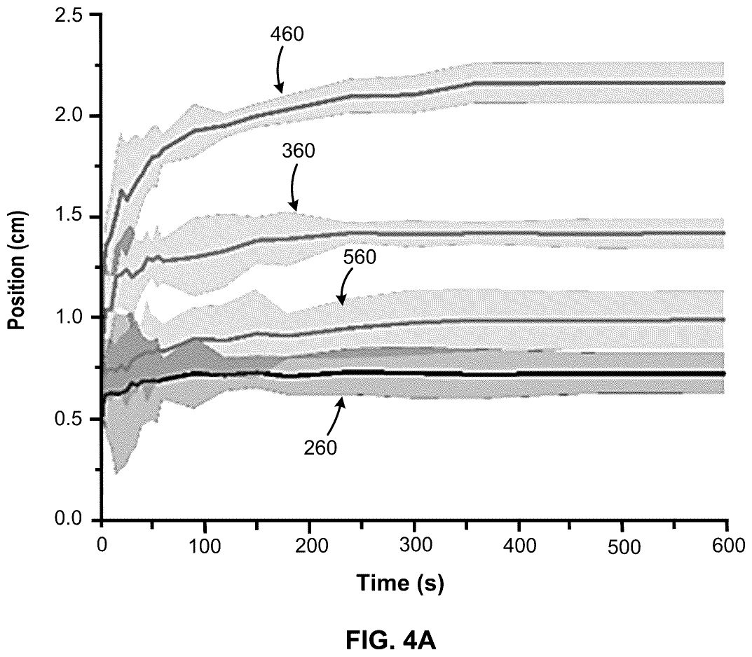

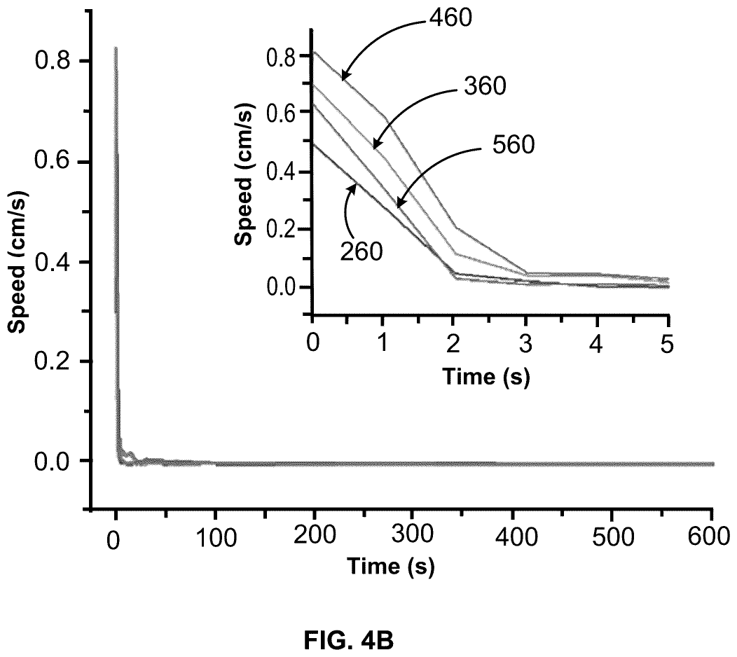

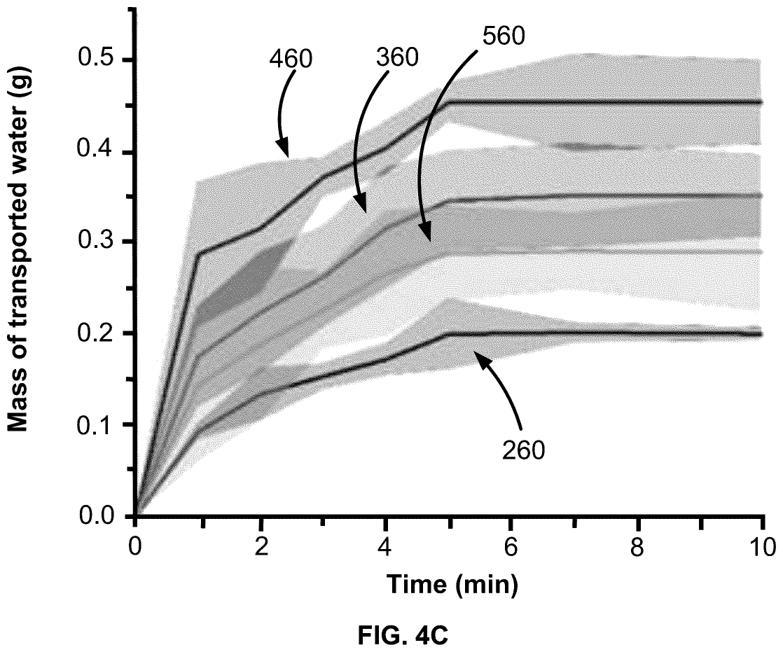

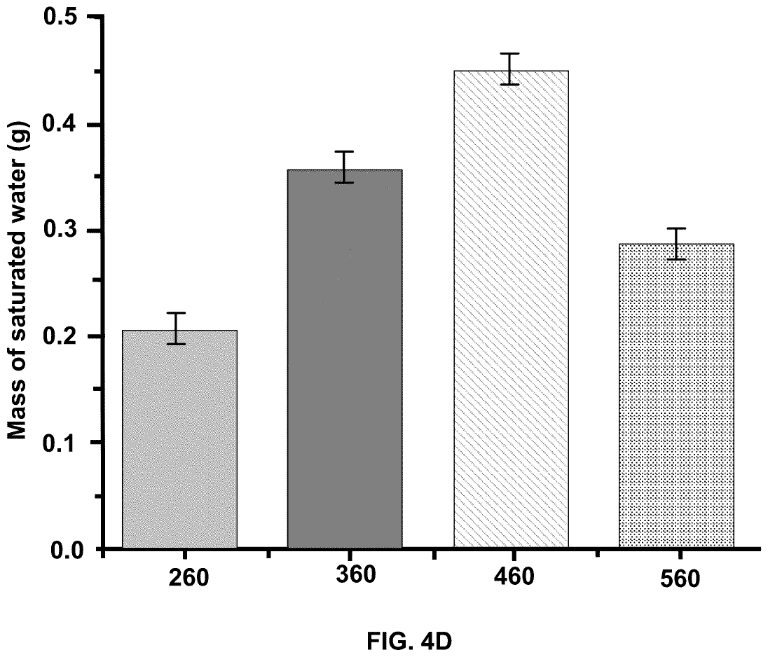

With reference to FIG. 4A, a graph depicting water rise (measured in centimeters) over time (measured in seconds) for each of PAAm-based aerogels structures 260, 360, 460, 560 is illustrated. With reference to FIG. 4B, a graph depictive transportation speeds (measured in centimeters per second) over time (measured in seconds) for each of PAAm-based aerogels structures 260, 360, 460, 560 is illustrated. With reference to FIG. 4C, a graph depicting mass changes (measured in grams) over time (measured in minutes) for each of PAAm-based aerogels structures 260, 360, 460, 560 is illustrated. With reference to FIG. 4D, a graph depicting mass saturated transported water (measured in grams) for each of PAAm-based aerogels structures 260, 360, 460, 560 is illustrated.

It is demonstrated that the RL channel structure 460 exhibited the longest water transport distance (approximately 2 cm within 100 seconds), the highest water transport speed (approximately 0.8 cm/s at the initial stage), and the greatest transported mass (approximately 0.45 ±0.01 g within 10 minutes). This superior performance is attributed to the combination of capillary rise and the gradient of Laplace pressure, which provides additional driving forces for water transport. In contrast, the straight channel structure 360 only provided capillary forces, and the inner RL structure 560 relied primarily on the gradient of Laplace pressure due to its larger diameter. Based on these findings, Laplace surface channels 464 provided improved water transport.

To further optimize the efficiency of solar steam generation, RL channel structure 460 were fabricated using photocurable resins with varying concentrations of rGO (from 0 wt. % to 0.15 wt. %).

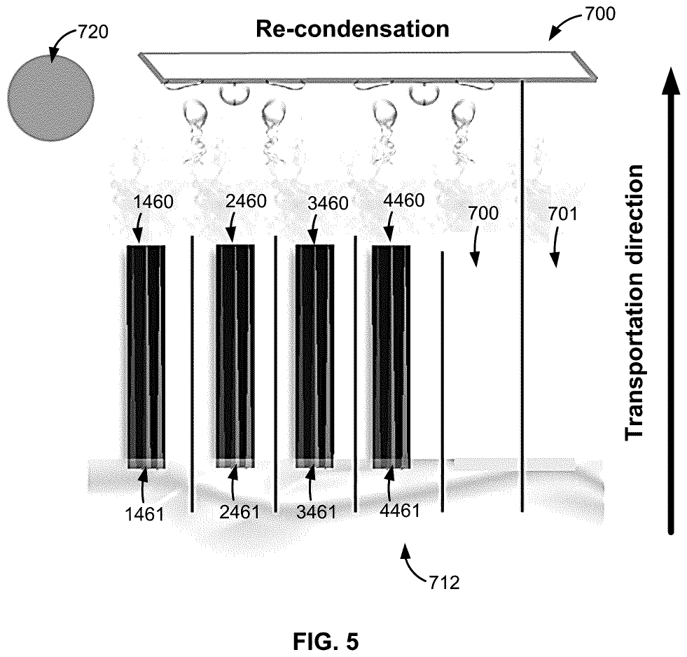

With reference to FIG. 5, the solar steam generation for aerogels with reverse Laplace surface channels fabricated using photocurable resins with varying concentrations of rGO particles 128 (from 0 wt. % to 0.15 wt. %) is illustrated. In various embodiments, RL channel structure samples 1460, 2460, 3460, 4460 similar to RL channel structure 460 and with various rGO particle 128 levels may be positioned above water 712. RL channel structure sample 1460 may comprise 0 wt. % of rGO particles 128. RL channel structure sample 2460 may comprise 0.05 wt. % of rGO particles 128. RL channel structure sample 3460 may comprise 0.10 wt. % of rGO particles 128. RL channel structure sample 4460 may comprise 0.15 wt. % of rGO particles 128. Bottom surfaces 1461, 2461, 3461, 4461 of RL channel structure samples 1460, 2460, 3460, 4460 may be immersed in the water 712. In various embodiments, RL channel structure samples 1460, 2460, 3460, 4460 may be exposed to an energy source. In various embodiments, RL channel structure samples 1460, 2460, 3460, 4460 may be exposed to a solar simulator 720 (for example, the 10500, ABET Technologies). In various embodiments, the solar simulator 720 may have a light intensity of 1 sun. In various embodiments, RL channel structure samples 1460, 2460, 3460, 4460 may be exposed to energy emitted from the solar simulator 720. The energy from the solar simulator 720 may cause at least some amount of the water 712 transported in the RL channel structure samples 1460, 2460, 3460, 4460 to evaporate. In various embodiments, a control sample 700 of water 712 may be exposed to the solar simulator 720. In various embodiments, a control sample 701 of water 712 may be prevented from exposure to the solar simulator 720.

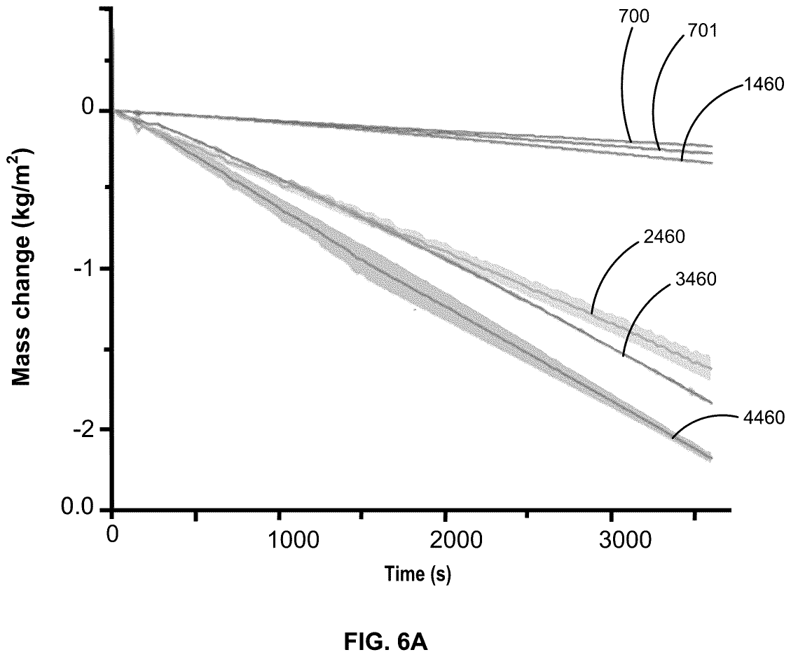

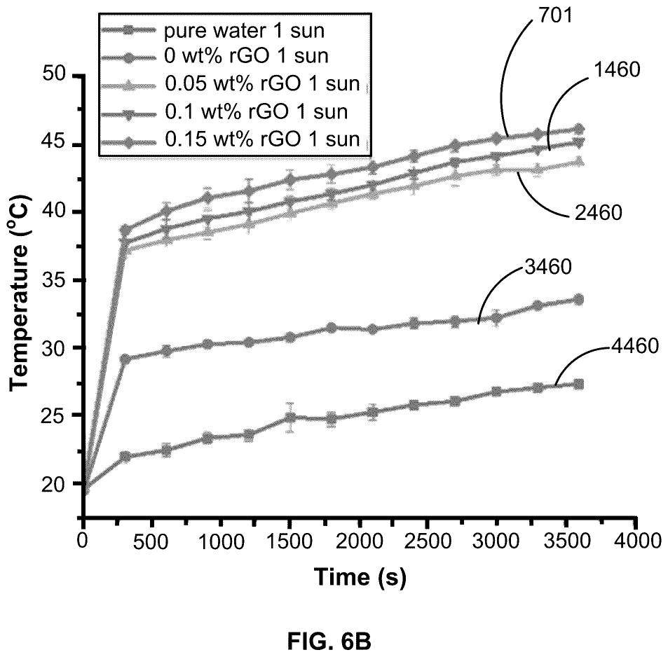

With reference to FIG. 6A, graphs demonstrate the mass change (measured in kilograms per square meter) over time (measured in seconds) due to a combination of water transport, water evaporation, and the temperature change on the RL channel structure samples 1460, 2460, 3460, 4460 and the control samples 700, 701 are illustrated. With respect to control sample 700, the mass change (measured in kilograms per square meter) over time (measured in seconds) of the control sample 700 exposed to the solar simulator 720 without an RL channel structure sample is illustrated. With respect to control sample 701, the mass change (measured in kilograms per square meter) over time (measured in seconds) of the control sample 701 without exposure to the solar simulator 720 and without an RL channel structure sample is illustrated. With reference to FIG. 6B, graphs demonstrating a temperature change (measured in degrees Celsius) over time (measured in seconds) for each of control sample 701 and RL channel structure samples 1460, 2460, 3460, 4460 are illustrated. As shown, as the concentration of rGO particles 128 increased, both the maximum temperature of the RL channel structure samples 1460, 2460, 3460, 4460 and the solar steam generation efficiency improved. This increase in efficiency is due to higher rGO particle 128 concentrations as the rGO particles 128 absorb more solar energy and thus accelerate the water evaporation process. As shown, RL channel structure sample 4460 with approximately 0.15 wt. % rGO particles 128 may be an optimal concentration for the photocurable resin 130 in terms of water transport and evaporation performance.

Used herein, acrylamide 126 may be AAm, 99 %. N, N'-methylenebisacrylamide may be MBAA, 99%. Used herein, methylene blue may be of a dye content of ≥82%. Used herein, diphenyl (2,4,6-trimethylbenzoyl) phosphine oxide may be TPO, 97%. Used herein, deionized water 122 may be DI water, ACS. Used herein, rGO particles 128 may have an average particle size of 5 μm.

For the resin containing 0.15 wt. % rGO, the following procedure may be used: For 10 grams (g) of resin, 6.000 g of Aam 126, 0.651 g of MBAA 124, 0.015 g of TPO as UV photoinitiator 129, and 0.015 g of rGO particles 128 may be dissolved in 3.319 g of DI water 122. The mixture may be sonicated in an ultrasonic bath for 30 minutes. For resins with varying rGO particle 128 concentrations, the rGO particle 128 mass and DI water 122 mass may be adjusted accordingly, while the mass of other materials may remain constant.

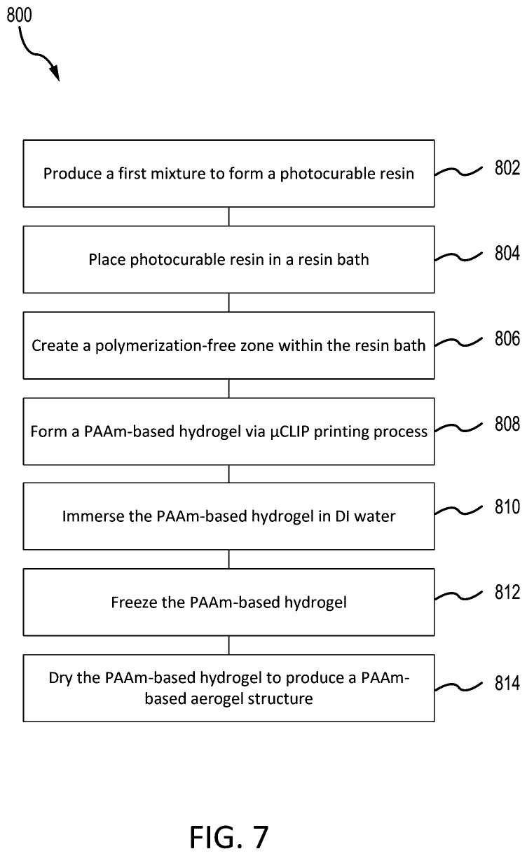

With reference to FIG. 7, a method 800 of manufacturing a polyacrylamide-based aerogel is illustrated. In various embodiments, step 802 may comprise producing a first mixture 120, as described above. In various embodiments, producing the first mixture 120 may include dissolving a monomer 126 into the solvent 122. In various embodiments, producing the first mixture 120 may include dissolving crosslinker 124 into the solvent 122. In various embodiments, producing the first mixture 120 may include dissolving at least one photoinitiator 129 into the solvent 122. In various embodiments, producing the first mixture 120 may include dissolving rGO particles 128 of various concentrations into the solvent 122. In various embodiments, producing the first mixture 120 may include homogeneously doping the first mixture 120 with rGO particles 128 in various concentrations. In various embodiments, producing the first mixture 120 may include producing a photocurable resin 130.

In various embodiments, at step 804, the photocurable resin 130 may be placed in a resin bath 136. The resin bath 136 may comprise an oxygen-permeable membrane 134. The oxygen-permeable membrane 134 may facilitate oxygen 132 from the atmosphere diffusing through the oxygen-permeable membrane 134. In various embodiments, step 806 may include creating a polymerization-free zone 138 within the resin bath 136. The diffused oxygen 132 may inhibit polymerization of the photocurable resin 130 and allow for the photocurable resin 130 to freely flow within the resin bath 136.

In various embodiments, at step 808, the photocurable resin 130 may be printing in a μCLIP printing process. Step 808 may include slicing a computer-aided design (CAD) model of the desired structure into 2D images along the printing direction. Step 808 may include directing a UV light source at the photocurable resin 130. Directing the UV light may include directing the UV light via a digital micromirror device 146. The UV light may be directed toward a transparent window 148 of the resin bath 136. In various embodiments, the UV light may be patterned. The UV light and projected images may be monitored by a Complementary Metal-Oxide-Semiconductor (CMOS) camera 149. In various embodiments, step 808 may include adjusting a position of the resin bath 136 via a motorized translation stage. In this manner, step 808 may include selectively polymerizing the photocurable resin 130 into solid layers. In various embodiments, 808 may include selectively polymerizing the photocurable resin 130 into solid layers via the μCLIP printing process to form PAAm-based hydrogel structures 150, as described above.

In various embodiments, step 810 may include immersing the PAAm-based hydrogel structures 150 in DI water, as described above, to produce swollen PAAm-based hydrogel structures 150. In various embodiments, step 810 may include soaking the PAAm-based hydrogel structures 150 in DI water.

In various embodiments, step 812 may include rapidly freezing the swollen PAAm-based hydrogel structures 150, as described above, to produce frozen PAAm-based hydrogel structure 150.

In various embodiments, step 814 may include freeze drying the frozen PAAm-based hydrogel structure 150, as described above, to produce a PAAm-based aerogel structures 160. The PAAm-based aerogel structure 160 may comprise a porous internal structure, as described above. The porous internal structure may comprise internal pores 162. The porous internal structure of each PAAm-based aerogel structure 160 may comprise surface channels 164. The PAAm-based aerogel structures 160 may comprise the properties detailed herein.

The systems and methods of manufacturing three-dimensional polymeric-based aerogels for use in solar steam generation disclosed herein represent a novel solar steamer with multiple water transportation driving forces manufactured using the μCLIP technique. This effort has innovations in the aspects of advanced fabrication method, structural design, and material composition, which marks a significant advancement in solar steam generation technology.

For the sake of brevity, conventional techniques and components for chemical processes, aerogel formation, 3D printing, and/or the like may not be described in detail herein. Furthermore, the connecting lines shown in various figures contained herein are intended to represent exemplary functional relationships and/or communicative couplings between various elements. It should be noted that many alternative or additional functional relationships or communicative connections may be present in exemplary methods and systems for forming aerogels and/or components thereof.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “about” or “approximately” mean +/−10% of a given value.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A polyacrylamide-based aerogel, comprising;
an elongate structure comprising a plurality of reduced graphene oxide particles dispersed within a resin comprising polyacrylamide, the elongate structure defining surface channels.

2. The polyacrylamide-based aerogel of claim 1, wherein the resin is approximately 0.15 wt. % rGO particles.

3. The polyacrylamide-based aerogel of claim 1, wherein the surface channels define reverse Laplace structures.

4. The polyacrylamide-based aerogel of claim 1, wherein the surface channels are configured to produce a transport force in response to being in contact with a liquid, and wherein the elongate structure further comprises a plurality of internal pores configured to produce a capillary force in response to being in contact with liquid.

5. A method of manufacturing a polyacrylamide-based aerogel, comprising:
mixing a monomer and a solvent to produce a photocurable resin;
selectively polymerizing the photocurable resin in layers to produce a hydrogel structure;
immersing the hydrogel structure in water to produce a swollen hydrogel structure;
freezing the swollen hydrogel structure to produce a frozen hydrogel structure; and
drying the frozen hydrogel structure.

6. The method of claim 5, wherein mixing the photocurable resin further comprising mixing the monomer and the solvent with reduced graphene oxide particles.

7. The method of claim 6, wherein the photocurable resin is approximately 0.15 wt. % rGO particles.

8. The method of claim 5, further comprising:
forming a first surface feature of the hydrogel structure configured to produce a capillary force in response to being in contact with liquid; and
forming a second surface feature configured to produce a transport force in response to being in contact with liquid.

9. The method of claim 8, wherein the first surface feature comprises a plurality of irregular-shaped, micron-scale internal pores and the second surface feature is a reverse Laplace structure forming an elongate channel.

10. The method of claim 5, further comprising, prior to selectively polymerizing the photocurable resin, containing the photocurable resin in a resin bath having an oxygen-permeable membrane configured to diffuse atmospheric oxygen.

11. A solar vapor generation device, comprising:
a first surface feature configured to produce a capillary force in response to being in contact with liquid, and a second surface feature configured to produce a transport force in response to being in contact with liquid.

12. The solar vapor generation device of claim 11, wherein the first surface feature comprises a plurality of irregular-shaped, micron-scale internal pores.

13. The solar vapor generation device of claim 12, wherein the second surface feature is a surface channel.

14. The solar vapor generation device of claim 13, wherein the second surface feature is a surface channel with a reverse Laplace structure.

15. The solar vapor generation device of claim 11, wherein the solar vapor generation device produces antigravity water transport of 0.45 g within 10 minutes.

16. The solar vapor generation device of claim 11, comprising an aerogel made from a crosslinked polyacrylamide-based aerogel with longitudinal grooves.

17. The solar vapor generation device of claim 11, comprising an aerogel fabricated via micro continuous liquid interface projection and freeze-drying.

18. The solar vapor generation device of claim 11, comprising a polyacrylamide-based aerogel.

19. The solar vapor generation device of claim 11, comprising homogeneously doped reduced graphene oxide (rGO).

20. The solar vapor generation device of claim 19, wherein the solar vapor generation device produces a solar vapor generation rate of 2.1 kg m⁻² h⁻¹ under 1 sun irradiation.
